(19) United States
(12) Patent Application Publication
(10) Pub. No.: US 2014/0270230 A1
(43) Pub. Date: Sep. 18, 2014

(54) IN-EAR HEADPHONES CONFIGURED TO RECEIVE AND TRANSMIT AUDIO SIGNALS AND RELATED SYSTEMS AND METHODS

(71) Applicant: SKULLCANDY, INC., Park City, UT (US)

(72) Inventors: Tetsuro OISHI, Park City, UT (US); Rex PRICE, Saratoga Springs, UT (US)

(73) Assignee: Skullcandy, Inc., Park City, UT (US)

(21) Appl. No.: 13/839,030

(22) Filed: Mar. 15, 2013

(51) Int. Cl. H04R 1/10

(52) U.S. Cl. CPC H04R 1/1041
USPC 381/74

(57) ABSTRACT

Methods of transmitting and receiving audio using in-ear headphones may comprise receiving sound from an ear canal at an in-ear headphone comprising a flexible insert, the flexible insert forming a seal between walls defining the ear canal and the flexible insert. The sound may be converted to an audio signal using the in-ear headphone in a receiving mode. The audio signal may be transmitted from the in-ear headphone to an audio signal transmitting and receiving device. The in-ear headphone may receive an audio signal from the audio signal transmitting and receiving device. The audio signal may be converted to sound and the sound may be transmitted into the ear canal using the in-ear headphone in a transmitting mode.

### FIELD

The disclosure relates generally to in-ear headphones. More specifically, disclosed embodiments relate to in-ear headphones including a microphone within a housing of the in-ear headphones, the microphone configured to convert sound conducted to an ear canal in which the in-ear headphones are at least partially inserted, into audio signals.

### BACKGROUND

Many devices are equipped to both provide and receive audio signals. For example, mobile phones (e.g., smartphones), tablet computers, laptop computers, hybrid computers, and desktop computers all frequently include the capability to play, record, transmit, and receive audio signals. Conventionally, peripheral devices, such as speakers and microphones, are used to access these capabilities. Some attempts have been made to integrate speakers and microphones into a single peripheral device to facilitate easy access to both receipt and transmission of audio. For example, U.S. Pat. No. 7,395,090, issued Jul. 1, 2008, to Alden, the disclosure of which is incorporated herein in its entirety by this reference, discloses a set of in-ear headphones configured to play audio and an in-line microphone positioned at or below a junction of the wires extending to the in-ear headphones. A jack may connect such a peripheral device to the main device (e.g., any of the computing devices previously mentioned) and enable a user to play, record, transmit, and receive audio.

One conventional use for such headphone devices is to make and receive contemporaneous audio transmissions, such as telephone calls or voice-over-internet-protocol (VoIP) messages. Audio captured by conventional microphones of the headphone devices may be difficult to perceive and understand because the microphone may capture audio not intended for transmission, such as background noise and noise generated by wind on the microphone. Some attempts have been made to filter out the unwanted noise to present a clearer, more focused audio signal. For example, U.S. Pat. No. 8,358,788, issued Jan. 22, 2013, to Heyl et al., the disclosure of which is incorporated herein in its entirety by this reference, discloses noise cancellation involving comparing the incoming signal from the microphone to a reference signal from an audio host device, and altering the incoming signal to reduce the noise present therein.

### BRIEF SUMMARY

In some embodiments, in-ear headphones configured to transmit and receive audio comprise a housing supporting at least one driver configured to operatively connect to an audio signal transmitting and receiving device within the housing. A flexible insert is connected to the housing, the flexible insert being configured for receipt within an ear canal to form a seal between walls defining the ear canal and the flexible insert. The in-ear headphone is configured to operate in a transmitting mode, in which audio signals are sent to the at least one driver, and in a receiving mode, in which audio signals are received from the at least one driver.

In other embodiments, audio transmitting and receiving systems comprise an audio signal transmitting and receiving device and a pair of in-ear headphones operatively connected to the audio signal transmitting and receiving device. At least one of the in-ear headphones comprises a housing supporting at least one driver operatively connected to the audio signal transmitting and receiving device within the housing. A flexible insert is connected to the housing, the flexible insert being configured for receipt within an ear canal to form a seal between walls defining the ear canal and the flexible insert. The at least one of the in-ear headphones is configured to operate in a transmitting mode, in which audio signals are sent to the at least one driver, and in a receiving mode, in which audio signals are received from the at least one driver.

In still other embodiments, methods of transmitting and receiving audio using in-ear headphones comprise receiving sound from an ear canal at at least one driver supported within a housing of an in-ear headphone comprising a flexible insert connected to the housing, the flexible insert forming a seal between walls defining the ear canal and the flexible insert. The sound is converted to an audio signal using the at least one driver when the in-ear headphone is in a receiving mode. The audio signal is transmitted from the at least one driver to an audio signal transmitting and receiving device operatively connected to the at least one driver. An audio signal from the audio signal transmitting and receiving device is received at the at least one driver. The audio signal is converted to sound and the sound is transmitted into the ear canal using the at least one driver when the in-ear headphone is in a transmitting mode.

This summary does not limit the scope of the invention, and is not intended to identify key features or aspects of the invention, but merely provides a generalized description of the nature of the subject matter disclosed herein. The scope of the invention is defined by the claims and their legal equivalents.

### BRIEF DESCRIPTION OF THE DRAWINGS

While the disclosure concludes with claims particularly pointing out and distinctly claiming embodiments encompassed by the disclosure, various features and advantages of embodiments within the scope of the disclosure may be more readily ascertained from the following description when read in conjunction with the accompanying drawings, in which:

FIG. 1 is a front view of an audio transmitting and receiving system;

FIG. 2 is a simplified cross-sectional view of an in-ear headphone of the audio transmitting and receiving system of FIG. 1;

FIG. 3 is a partial cross-sectional side view of a multiple-contact connector and an associated receptacle of the audio transmitting and receiving system of FIG. 1;

FIG. 4 is a partial cross-sectional front view of the audio transmitting and receiving system in use; and

FIG. 5 is a simplified cross-sectional view of another embodiment of an in-ear headphone.

### DETAILED DESCRIPTION

The illustrations presented herein are not meant to be actual views of any particular audio transmitting and receiving system, in-ear headphone, multiple-contact connector, or component thereof, but are merely idealized representations employed to describe illustrative embodiments. Thus, the drawings are not necessarily to scale.

Disclosed embodiments relate generally to in-ear headphones including a microphone within a housing of the in-ear headphones configured to convert into audio signals sound conducted to an ear canal in which the in-ear headphones are at least partially inserted. In some embodiments, in-ear headphones may include a driver configured to perform in at least two operational modes: a transmitting mode in which the driver acts as a speaker and a receiving mode in which the driver acts as a microphone. In other embodiments, in-ear headphones may include a speaker and a microphone within the same housing, and sound within the ear canal in which the in-ear headphone is partially inserted (e.g., a user's voice conducted to the ear canal by bone conduction) may be picked up by the microphone and converted to an audio signal. More generally, disclosed are in-ear headphones that may reduce unwanted noise in sound received by a microphone and, in some embodiments, may not require a separate microphone (e.g., an in-line microphone) to operate as a microphone.

Referring to FIG. 1, a front view of an audio transmitting and receiving system 100 is shown. The audio transmitting and receiving system 100 may include an audio signal transmitting and receiving device 102 configured and programmed to transmit audio signals for playback and to receive audio signals for recording or transmission to another device over a network (e.g., the Internet or a local area network (LAN)). The audio signal transmitting and receiving device 102 may comprise, for example, a portable media player (PMP) (e.g., a portable DVD player, portable gaming console, portable stereo, etc.), mobile phone, tablet computer, laptop computer, desktop computer, gaming console, or other device configured to transmit and receive audio signals.

An audio transmitting and receiving peripheral device 104 including a pair of in-ear headphones 106 may be operatively connected to the audio signal transmitting and receiving device 102. The in-ear headphones 106 may be configured to be at least partially inserted into a user's ear canal when in use. The in-ear headphones 106 may be configured to receive audio signals from the audio signal transmitting and receiving device 102 and convert the audio signals into sound. The in-ear headphones 106 may also be configured to receive sound from the environment in which they are located, convert the sound to an audio signal, and transmit the audio signal to the audio signal transmitting and receiving device 102. In other words, one or each of the in-ear headphones 106 may operate both as a speaker and as a microphone. Because at least one of the in-ear headphones 106 themselves may operate as a microphone, the audio transmitting and receiving peripheral device 104 may not include any microphones other than the in-ear headphones 106.

A wire 108 and 110 configured to carry the audio signals to and from each in-ear headphone 106 may extend from each in-ear headphone 106 to converge at a juncture 112 in some embodiments. The converged wire 114 may extend from the juncture 112 to a multiple-contact connector 116 configured to operatively connect the audio transmitting and receiving peripheral device 104 to the audio signal transmitting and receiving device 102. In other embodiments, the audio transmitting and receiving peripheral device 104 may include a wireless connector 148 (see FIG. 5) (e.g., Bluetooth® technology) configured to connect wirelessly to an adapter comprising a multiple-contact connector 116 configured to operatively connect the audio transmitting and receiving peripheral device 104 to the audio signal transmitting and receiving device 102 or to wirelessly connect directly to the audio signal transmitting and receiving device 102.

In some embodiments, the audio transmitting and receiving peripheral device 104 may include a control module 118 configured to transmit control signals to the audio signal transmitting and receiving device 102 to control its operation. For example, the control module 118 may be configured in at least substantially the same way and may operate in at least substantially the same manner as the user input interface described in U.S. Pat. No. 7,623,667, issued Nov. 24, 2009, to Sander et al., the disclosure of which is incorporated herein in its entirety by this reference. For example, the control module 118 may include internal switches and contacts configured to generate ultrasonic audio signals that travel through the wires 108 and 114 and the multiple-contact connector 116, or through wireless transmission, to the audio signal transmitting and receiving device 102, which may interpret the ultrasonic audio signals and perform a desired operation. The control module 118 may not include a microphone.

Referring to FIG. 2, a cross-sectional view of an in-ear headphone 106 of the audio transmitting and receiving system 100 of FIG. 1 is shown. The in-ear headphone 106 may include a housing 120 configured to contain electronic components of the in-ear headphone 106. The housing 120 may be rigid to protect fragile components housed therein. The wire 108 may extend within the housing 120 for connection to a single driver 122 (e.g., a loudspeaker, an electroacoustic transducer, an electrodynamic loudspeaker, etc.) housed within and supported by the housing 120 in some embodiments. The driver 122 may be configured to receive audio signals from the wire 108 and to convert the audio signals to sound. The driver 122 may also be configured to receive sound from the surrounding environment, convert the sound to audio signals, and transmit the audio signals to the wire 108. For example, the driver 122 may comprise a transducer 123 configured to convert audible sound into electrical signals and to convert electrical signals into audible sound. In other words, the driver 122 may be configured to act both as a speaker and as a microphone pickup.

The in-ear headphone 106 may further include a flexible insert 124 configured to be at least partially inserted into an ear canal of a user and to form a seal with the walls defining the ear canal. For example, the in-ear headphone 106 may include a flexible insert 124 having an annular shape within which a protrusion 125 of the housing 120 is received to connect the flexible insert 124 to the housing. The flexible insert 124 may comprise a flexible, deformable material configured to deform elastically when introduced into the ear canal and to return resiliently to its original shape when removed from the ear canal. For example, the flexible insert 124 may comprise silicone.

Referring to FIG. 3, a partial cross-sectional side view of the multiple-contact connector 116 and an associated receptacle of the audio transmitting and receiving system of FIG. 1 is shown. The multiple-contact connector 116 may include at least three contacts 126 of an electrically conductive material configured to interface with the audio signal transmitting and receiving device 102 to relay audio signals to and from the in-ear headphones 106. For example, the multiple-contact connector 116 may include a first contact 126A, a second contact 126B, a third contact 126C, and a fourth contact 126D. In some embodiments, the multiple-contact connector 116 may comprise, for example, a tip-ring-sleeve (TRS) audio jack or a tip-ring-ring-sleeve audio jack. More specifically, the multiple contact connector 116 may comprise, for example, a first contact 126 configured as the tip of a TRRS audio jack, a second contact 126B configured as a ring adjacent the tip of a TRRS audio jack, a third contact 126C configured as a ring of a TRRS audio jack adjacent the second contact 126B on a side opposing the side on which the first contact 126A is located, and a third contact 126C configured as the sleeve of a TRRS audio jack. In other embodiments, the multiple-contact connector 116 may comprise, for example, a jack plug.

The audio signal transmitting and receiving device 102 may include an interface 128 including corresponding contacts 130A, 130B, 130C, and 130D configured to operatively connect to the contacts 126A, 126B, 126C, and 126D of the multiple-contact connector 116. For example, the interface 128 may comprise jack plug (e.g., a jack socket) with a corresponding number of contacts 130 configured to connect with the contacts 126 of the audio jack of the multiple-contact connector 116. More specifically, the interface 128 may comprise a receptacle 134 into which the multiple-contact connector 116 may be at least partially inserted. Walls defining the receptacle 134 may be lined with an electrically conductive material. A portion of the electrically conductive material lining the walls of the receptacle 134 may form a protrusion 132 at each of the corresponding contacts 130A, 130B, 130C, and 130D to abut against respective contacts 126A, 126B, 126C, and 126D of the multiple-contact connector 116 and form an electrical connection.

The contacts 126 and 130 may enable the audio transmitting and receiving peripheral device 104 (see FIG. 1) to function in at least two operational modes: a transmitting mode in which the in-ear headphones 106 (see FIGS. 1, 2) operate as speakers and a receiving mode in which at least one of the in-ear headphones 106 (see FIGS. 1, 2) operates as a microphone. When the transmitting and receiving peripheral device 104 (see FIG. 1) is in a transmitting mode, each of the in-ear headphones 106 (see FIGS. 1, 2) may operate as a speaker. For example, the first and second contacts 126A and 126B (e.g., acting as left and right audio out) may receive audio signals from the corresponding contacts 130A and 130B of the interface 128 and relay them to respective drivers 122 of each of the left- and right-ear in-ear headphones 106 to be converted into and emitted as sound when the audio transmitting and receiving peripheral device 104 (see FIG. 1) is in the transmitting mode. In the transmitting mode, the third contact 126C may perform as an electrical ground, and the fourth contact 126D may not be in active use.

When the transmitting and receiving peripheral device 104 (see FIG. 1) is in a receiving mode, at least one of the in-ear headphones 106 (see FIGS. 1, 2) may operate as a microphone. For example, the first contact 126A (e.g., acting as the only audio in) may receive audio signals from a corresponding in-ear headphone 106 (see FIGS. 1, 2) of the transmitting and receiving peripheral device 104 (see FIG. 1) and relay them to its corresponding contact 130A of the interface 128. The audio signal may be relayed from the corresponding contact 130A to a processing unit 136, which may include at least one of an amplifier, a filter, and an equalizer configured to modify an incoming audio signal. The processing unit 136 may increase a signal-to-noise ratio (SNR) of the audio signal to increase its intelligibility and filter out undesirable background noise. The modified audio signal may then be relayed to the fourth contact 126D (e.g., acting as mic in) of the multiple-contact connector 116 and its corresponding contact 130D of the interface 128, where it may be received by the audio signal transmitting and receiving device 102, for example, for recording or relaying to another device over a network. In such a receiving mode, the second contact 126B may not be in active use, and the third contact 126C may perform as an electrical ground. As an alternative example, the first and second contacts 126A and 126B (e.g., acting as left and right audio in) may receive audio signals from each of their corresponding in-ear headphone 106 (see FIGS. 1, 2) of the transmitting and receiving peripheral device 104 (see FIG. 1) and relay them to their corresponding contacts 130A and 130B of the interface 128. The audio signals may be combined (as indicated in dashed lines) and relayed from the corresponding contacts 130A and 130B to a processing unit 136, which may include at least one of an amplifier, a filter, and an equalizer configured to modify an incoming audio signal. The processing unit 136 may increase the SNR of the audio signal to increase its intelligibility and filter out undesirable background noise. The processed audio signal may then be relayed to the fourth contact 126D (e.g., acting as mic in) of the multiple-contact connector 116 and its corresponding contact 130D of the interface 128, where it may be received by the audio signal transmitting and receiving device 102, for example, for recording or relaying to another device over a network. In such a receiving mode, the third contact 126C may perform as an electrical ground.

Referring to FIG. 4, a partial cross-sectional front view of the audio transmitting and receiving system 100 is shown in use. The in-ear headphone 106 may be partially inserted into the ear canal 138. More specifically, the flexible insert 124 may be at least partially inserted into the ear canal 138 and may form a seal against walls 140 defining the ear canal 138 to reduce the ability of ambient noise from the surrounding environment to impact the driver 122 (see FIG. 2) within the in-ear headphone 106. Such a configuration may reduce the amount of processing required to be performed to achieve an adequate SNR for the purposes of understanding sound (e.g., a user's voice) received via the in-ear headphone 106 when in the receiving mode. When it is said that the flexible insert 124 forms a “seal” against the walls 140 of the ear canal 138, what is meant is that a substantial portion (e.g., all) of the flexible insert 124 is in contact with the walls 140 of the ear canal 138 such that the in-ear headphone 106 is fixed in place by frictional interference between the walls 140 of the ear canal 138 and the flexible insert 124. Such isolation may enable the driver 122 (see FIG. 2), which may otherwise be unsuitable for use as a microphone, to receive sound (e.g., the user's voice) with sufficient fidelity to capture an intelligible audio signal, without capturing undesirable environmental noise (e.g., wind directly impacting the driver (see FIG. 2)).

When the audio transmitting and receiving peripheral device 104 is in the transmitting mode, the in-ear headphones 106 may operate in much the same way as conventional in-ear headphones by converting audio signals from the audio signal transmitting and receiving device 102 into audible sound and emitting the sound into the ear canal 138. The audio transmitting and receiving peripheral device 104 may switch between the transmitting mode and the receiving mode in response to user input in some embodiments. For example, a user may manually switch between the transmitting mode and the receiving mode by manipulating (e.g., pressing, pressing and holding, pressing a set number of times, etc.) the control module 118, which may relay a control signal to the audio signal transmitting and receiving device 102. In other embodiments, the audio transmitting and receiving peripheral device 104 may automatically switch between the transmitting mode and the receiving mode in response to, for example, a signal from the audio signal transmitting and receiving device 102 indicating an incoming telephone call, or the absence of any audio signal to be transmitted to the in-ear headphones 106 for playback as speakers or detection of sound intended for receipt (e.g., a user's voice).

When the audio transmitting and receiving peripheral device 104 is in the receiving mode, sounds within the ear canal 138 may impact the driver 122 (see FIG. 2) and be converted into audio signals. For example, a user's voice may be relayed (e.g., by bone conduction) from the larynx to the ear canal 138, where it may impact the driver 122, and the driver 122 may convert the user's voice into an audio signal. The audio signal may be relayed along the wires 108 and 114 to the multiple-contact connector 116, where it may be processed to increase its SNR and ultimately transferred to the audio signal transmitting and receiving device 102 (e.g., for recording or transmitting to another device over a network).

Referring to FIG. 5, a simplified cross-sectional view of another embodiment of an in-ear headphone 106′ is shown. The in-ear headphone 106′ may include a microphone 142 and a speaker 144 supported within the housing 120. For example, each of the microphone 142 and the speaker 144 may comprise a separate driver 122A and 122B, one driver 122A configured to serve as the microphone 142 and the other driver 122B configured to serve as the speaker 144. The microphone 142 and the speaker 144 may be located within a common cavity 146 defined by the housing 120, which may open directly toward the ear canal 138 (see FIG. 4) in some embodiments. Wire 147 may extend within the housing 120 for connection between the drivers 122A and 122B and a wireless connector 148 housed within and supported by the housing 120 in some embodiments. The wireless connector 148 may be configured to connect wirelessly to an adapter connected to an audio signal transmitting and receiving device 102 (see FIGS. 1, 4) or directly to the audio signal transmitting and receiving device 102 (see FIGS. 1, 4) itself The first driver 122A may be configured to receive sound from the surrounding environment (e.g., from within an ear canal 138 (see FIG. 4)), convert the sound to audio signals, and transmit the audio signals to the wireless connector 148. The second driver 122B may be configured to receive audio signals from the wireless connector 148 and to convert the audio signals to sound. In embodiments where the in-ear headphone 106′ includes a wireless connector 148, the control module 118 may be directly connected to the housing 120, and wire 149 may connect the control module 118 to the wireless connector 148 to enable control signals to be transmitted to an audio signal transmitting and receiving device 102 (see FIGS. 1, 4). In other embodiments, each of the microphone 142 and the speaker 144 may be connected to a wire 108 (see FIGS. 1, 3) to enable the speaker 144 to receive audio signals from the audio signal transmitting and receiving device 102 (see FIGS. 1, 4) and convert them into emitted sound when the in-ear headphone 106′ is operating in a transmitting mode and to enable the microphone 142 to transmit audio signals produced by converting sounds within the ear canal to the audio signal transmitting and receiving device 102 (see FIGS. 1, 4) when the in-ear headphone 106′ is operating in a receiving mode, and the control module 118 may be connected in-line with the wire 108 (see FIGS. 1, 3).

When the flexible insert 124 of the in-ear headphone 106′ is at least partially inserted into an ear canal 138 (see FIG. 4) to form a seal against the walls 140 (see FIG. 4) defining the ear canal 138 (see FIG. 4), the sounds within the ear canal 138 (see FIG. 4), such as, for example, a user's voice conducted to the ear canal by bone conduction, may be picked up by the speaker 144, while environmental sounds may be at least partially obstructed (e.g., prevented) from being picked up by the speaker 144 because the seal between the walls 140 (see FIG. 4) defining the ear canal 138 (see FIG. 4) and the flexible insert 124 may muffle such sounds.

In some embodiments, the in-ear headphone 106′ may be configured to switch between the transmitting mode and the receiving mode in response to user input. For example, any of the methods for manually switching between the transmitting mode and the receiving mode discussed previously in connection with FIG. 4 may be used in connection with the separate microphone 142 and speaker 144 equally as well as with the single driver 122 (see FIG. 2). In other embodiments, the in-ear headphone 106′ may be configured to switch automatically between the transmitting mode and the receiving mode. For example, any of the methods for automatically switching between the transmitting mode and the receiving mode discussed previously in connection with FIG. 4 may be used in connection with the separate microphone 142 and speaker 144 equally as well as with the single driver 122 (see FIG. 2). In still other embodiments, the in-ear headphone 106′ may be configured to operate simultaneously in both the transmitting mode and the receiving mode. For example, the microphone 142 may be configured to convert sound within the ear canal into audio signals to relay to the audio signal transmitting and receiving device 102 (see FIGS. 1, 4) simultaneously as the speaker 144 converts other audio signals into emitted sound. In such embodiments, the processing unit 136 may be configured and programmed to filter out audio signals generated by the microphone 142 picking up sounds emitted from the speaker 144, such as, for example, by comparing the audio signals from the microphone 142 to the audio signals sent to the speaker 144.

While certain illustrative embodiments have been described in connection with the figures, those of ordinary skill in the art will recognize and appreciate that the scope of the disclosure is not limited to those embodiments explicitly shown and described herein. Rather, many additions, deletions, and modifications to the embodiments described herein may be made to produce embodiments within the scope of the disclosure, such as those hereinafter claimed, including legal equivalents. In addition, features from one disclosed embodiment may be combined with features of another disclosed embodiment while still being within the scope of the disclosure, as contemplated by the inventors.

What is claimed is:

1. An in-ear headphone configured to transmit and receive audio, comprising:
a housing supporting at least one driver configured to operatively connect to an audio signal transmitting and receiving device within the housing; and
a flexible insert connected to the housing, the flexible insert being configured for receipt within an ear canal to form a seal between walls defining the ear canal and the flexible insert;
wherein the in-ear headphone is configured to operate in a transmitting mode, in which audio signals are sent to the at least one driver, and in a receiving mode, in which audio signals are received from the at least one driver.

2. The in-ear headphone of claim 1, wherein the at least one driver comprises a single driver comprising a transducer configured to convert audible sound into an audio signal in the transmitting mode and to convert audio signals into audible sounds in the receiving mode.

3. The in-ear headphone of claim 2, further comprising a multiple-contact connector operatively connected to the single driver configured to operatively connect to the audio signal transmitting and receiving device.

4. The in-ear headphone of claim 3, wherein the multiple-contact connector comprises at least three contacts, comprising a first contact configured to transmit audio signals to the single driver in the transmitting mode and to receive audio signals in the receiving mode, a second contact configured as ground for the in-ear headphone, and a third contact configured to receive processed audio signals from the first contact and to transmit the processed audio signals to an audio signal transmitting and receiving device.

5. The in-ear headphone of claim 1, wherein the at least one driver comprises at least two drivers, comprising a first driver configured to convert audible sound into an audio signal and a second driver configured to convert audio signals into audible sound.

6. The in-ear headphone of claim 5, further comprising a multiple-contact connector operatively connected to each of the first and second drivers configured to operatively connect to the audio signal transmitting and receiving device.

7. The in-ear headphone of claim 6, wherein the multiple-contact connector comprises at least three contacts, comprising a first contact configured to receive audio signals from the first driver in the receiving mode and to transmit audio signals to the second driver in the transmitting mode, a second contact configured as ground for the in-ear headphone, and a third contact configured to receive processed audio signals from the first contact and to transmit the processed audio signals to an audio signal transmitting and receiving device.

8. The in-ear headphone of claim 1, comprising a wireless connector operatively connected to the at least one driver and configured to operatively connect to the audio signal transmitting and receiving device.

9. The in-ear headphone of claim 1, further comprising a control module operatively connected to the at least one driver, the control module being configured to transmit control signals to an audio signal transmitting and receiving device, wherein the control module lacks a microphone.

10. An audio transmitting and receiving system, comprising:
an audio signal transmitting and receiving device; and
a pair of in-ear headphones operatively connected to the audio signal transmitting and receiving device, at least one of the in-ear headphones comprising:
a housing supporting at least one driver operatively connected to the audio signal transmitting and receiving device within the housing; and
a flexible insert connected to the housing, the flexible insert being configured for receipt within an ear canal to form a seal between walls defining the ear canal and the flexible insert;
wherein the at least one of the in-ear headphones is configured to operate in a transmitting mode, in which audio signals are sent to the at least one driver, and in a receiving mode, in which audio signals are received from the at least one driver.

11. The audio transmitting and receiving system of claim 10, wherein the audio signal transmitting and receiving device comprises at least one of an amplifier, a filter, and an equalizer configured to modify an incoming audio signal from the at least one driver and to transmit the modified audio signal to the audio signal transmitting and receiving device.

12. The audio transmitting and receiving system of claim 11, wherein the at least one driver of at least one of the in-ear headphones comprises a single driver configured to convert audible sound into an audio signal and to convert audio signals into audible sound.

13. The audio transmitting and receiving system of claim 12, further comprising a multiple-contact connector operatively connected to the single driver and to the audio signal transmitting and receiving device, wherein the multiple-contact connector comprises at least four contacts, comprising a first contact configured to transmit audio signals to the single driver of the at least one of the in-ear headphones in the transmitting mode and to receive audio signals from the from the single driver in the receiving mode; a second contact configured to transmit audio signals to the at least one driver of the other of the in-ear headphones in the transmitting mode, at least the first contact being connected to the at least one of the amplifier, the filter, and the equalizer; a third contact configured as ground for each in-ear headphone; and a fourth contact configured to receive modified audio signals from the at least one of the amplifier, the filter, and the equalizer and to transmit the modified audio signals to the audio signal transmitting and receiving device.

14. The audio transmitting and receiving system of claim 11, wherein the at least one driver of at least one of the in-ear headphones comprises a first driver configured to convert audible sound into an audio signal and a second driver configured to convert audio signals into audible sound.

15. The audio transmitting and receiving system of claim 14, further comprising a multiple-contact connector operatively connected to each of the first and second drivers and to the audio signal transmitting and receiving device, wherein the multiple-contact connector comprises at least four contacts, comprising a first contact configured to transmit audio signals to the first driver of the at least one of the in-ear headphones in the transmitting mode and to receive audio signals from the second driver of the at least one of the in-ear headphones in the receiving mode; a second contact configured to transmit audio signals to the at least one driver of the other of the in-ear headphones in the transmitting mode, at least the first contact being connected to the at least one of the amplifier, the filter, and the equalizer; a third contact configured as ground for the in-ear headphones; and a fourth contact configured to receive modified audio signals from the at least one of the amplifier, the filter, and the equalizer and to transmit the modified audio signals to the audio signal transmitting and receiving device.

16. The audio transmitting and receiving system of claim 10, further comprising a wireless connector operatively connected to the at least one driver and to the audio signal transmitting and receiving device.

17. The audio transmitting and receiving system of claim 10, further comprising a control module operatively connected to the at least one driver and the audio signal transmitting and receiving device, the control module being configured to transmit control signals to the audio signal transmitting and receiving device, wherein the control module lacks a microphone.

18. A method of transmitting and receiving audio using an in-ear headphone, comprising:
receiving sound from an ear canal at at least one driver supported within a housing of an in-ear headphone comprising a flexible insert connected to the housing, the flexible insert forming a seal between walls defining the ear canal and the flexible insert;
converting the sound to an audio signal using the at least one driver when the in-ear headphone is in a receiving mode;
transmitting the audio signal from the at least one driver to an audio signal transmitting and receiving device operatively connected to the at least one driver;
receiving at the at least one driver an audio signal from the audio signal transmitting and receiving device; and
converting the audio signal to sound and transmitting the sound into the ear canal using the at least one driver when the in-ear headphone is in a transmitting mode.

19. The method of claim 18, wherein receiving the sound from the ear canal at the at least one driver; converting the sound to the audio signal using the at least one driver; receiving at the at least one driver the audio signal; and converting the audio signal to the sound and transmitting the sound into the ear canal using the at least one driver comprise receiving the sound from the ear canal at a single driver configured to convert audible sound into an audio signal and to convert audio signals to audible sound supported within the housing; converting the sound to the audio signal using the single driver; receiving at the single driver the audio signal; and converting the audio signal to the sound and transmitting the sound into the ear canal using the single driver.

20. The audio transmitting and receiving system of claim 18, wherein receiving the sound from the ear canal at the at least one driver; converting the sound to the audio signal using the at least one driver; receiving at the at least one driver the audio signal; and converting the audio signal to the sound and transmitting the sound into the ear canal using the at least one driver comprise receiving the sound from the ear canal at a first driver configured to convert audible sound to audio signals supported within the housing; converting the sound to the audio signal using the first driver; receiving at a second driver configured to convert audio signals to audible sound the audio signal; and converting the audio signal to the sound and transmitting the sound into the ear canal using the second driver.

21. The method of claim 18, further comprising switching between the receiving mode and the transmitting mode in response to user input at a control module operatively connected to the at least one driver and the audio signal transmitting and receiving device.
